(19) United States
(12) Patent Application Publication
(10) Pub. No.: US 2020/0193220 A1
(43) Pub. Date: Jun. 18, 2020

(54) METHOD FOR DATA IMPUTATION AND CLASSIFICATION AND SYSTEM FOR DATA IMPUTATION AND CLASSIFICATION

(71) Applicant: NATIONAL SUN YAT-SEN UNIVERSITY, Kaohsiung (TW)

(72) Inventor: Bo-Wei CHEN, KAOHSIUNG (TW)

(21) Appl. No.: 16/223,139

(22) Filed: Dec. 18, 2018

(51) Int. Cl. G06K 9/62; G06K 9/68

(52) U.S. Cl. CPC G06K 9/6235; G06K 9/6807; G06K 2009/6237; G06K 2009/6236; G06K 9/6206

(57) ABSTRACT

A method and a system for data imputation and classification are provided. The system includes a database, a historical sample imputation module and a current sample imputation and classification module. In the method, at first, an imputation calculation is performed on each of classified historical sample groups to obtain a basis matrix and a missing value corresponding to each of the classified historical sample groups. Thereafter, a sample classification stage is performed. In the sample classification stage, an IPP (Iterative Projection Pursuit) algorithm and an equation of nonlinear inequality constraints to calculate weighting vectors corresponding to a current sample. Thereafter, plural candidate samples corresponding to different classes are calculated in accordance with the basis matrix and the weighting vectors, and the sample class of the current sample and a prediction value for a missing value of the current sample are determined accordingly.

### BACKGROUND

### Field of Invention

The present invention relates to a method for data imputation and classification and a system for data imputation and classification.

### Description of Related Art

With the development of information technology, desired information can be obtained through various data analysis and processing methods. For example, through a data mining technology, data with specific relationships there between can be obtained from a database. For another example, through a classification technology, data in a database can be classified to benefit data arrangement. For still another example, through an imputation technology, missing values of data can be imputed.

Traditional imputation technologies include a multiple imputation algorithm, a Listwise Deletion algorithm, an interpolation algorithm, a K-nearest neighbor algorithm, and so on. However, the multiple imputation algorithm needs a large number of computation resources; the Listwise Deletion algorithm may lose important data information; the interpolation algorithm may crash when attribute fields have different numbers of missing values; the K-nearest neighbor algorithm needs to fill a predetermined fixed value into attribute fields, when the attribute fields have different numbers of missing values.

### SUMMARY

An aspect of the present invention is to provide a method for data imputation and classification and a system for data imputation and classification so as to overcome the shortages of the conventional imputation technologies.

In the method for data imputation and classification, at first, a data processing stage for historical samples is performed to impute historical samples and calculate corresponding base matrixes. In the historical sample processing stage, at first, the historical samples are provided. Then, the historical samples are classified into plural classes to obtain plural classified historical sample groups, in which the classified historical sample groups correspond to the classes in a one-to-one manner, and each of the classified historical sample groups includes plural known historical values and at least one historical missing value. Thereafter, the historical missing value is replaced with zero. Thereafter, an imputation calculating step is performed on each of the classified historical sample groups. In the imputation calculating step, at first, a base matrix and a weight matrix which are corresponded by each of the classified historical sample groups is calculated. Then, a predicted value of the at least one historical missing value of each of the classified historical sample groups is calculated in accordance with the base matrix and the weight matrix which are corresponded by each of the classified historical sample groups. After the historical sample processing stage, a sample classification stage is performed to classify a current sample into one of the classes, in which the current sample includes plural known values and at least one missing value. In the historical sample processing stage, at first, weight vectors corresponded by the current sample are calculated by using an iterative projection pursuit (IPP) algorithm and a nonlinear inequality constraint, in which the weight vectors correspond to the classes in a one-to-one manner, each of the weight vectors is limited by a weight parameter, and the weight parameter is calculated in accordance with the nonlinear inequality constraint. Then, a candidate sample calculating step is performed to calculate candidate samples corresponding to the classes in accordance with the base matrix and the weight vector corresponding to the same class, in which the candidate samples correspond to the classes in a one-to-one manner. Thereafter, a difference between the current sample and each of the candidate samples is calculated to obtain candidate sample differences. Then, a predicted value of the at least one missing value of the current sample and a class corresponded by the current sample are determined in accordance with the candidate sample differences.

In some embodiments, the nonlinear inequality constraint is a quadratic inequality constraint.

In some embodiments, the step for calculating the base matrix and the weight matrix which are corresponded by each of the classified historical sample groups is performed by using an alternating least squares (ALS) algorithm and class-dependent data imputation.

In some embodiments, the ALS algorithm is a ridge alternating least squares (RALS) algorithm.

In some embodiments, the candidate sample calculating step involves multiplying the base matrix by the weight vector to obtain each of the candidate samples.

With respect to the above system for data imputation and classification, the system for data imputation and classification includes a database, an imputation calculating module and an imputation and classification module. The database is configured to store classified historical sample groups, in which the classified historical sample groups correspond to plural classes in a one-to-one manner, and each of the classified historical sample groups includes plural known historical values and at least one historical missing value. The imputation calculating module for the historical samples is configured to replace the historical missing value with zero, calculate a base matrix and a weight matrix which are corresponded by each of the classified historical sample groups, and calculate a predicted value of the at least one historical missing value of each of the classified historical sample groups in accordance with the base matrix and the weight matrix which are corresponded by each of the classified historical sample groups. The imputation and classification module is configured to receive a current sample provided from an external device, and configured to calculate plural weight vectors corresponded by the current sample by using an iterative projection pursuit (IPP) algorithm and a nonlinear inequality constraint, in which the weight vectors correspond to the classes in a one-to-one manner, each of the weight vectors is limited by a weight parameter, and the weight parameter is calculated in accordance with the nonlinear inequality constraint. The imputation and classification module is further configured to perform a candidate sample calculating step to calculate plural candidate samples corresponding to the classes in accordance with the base matrix and the weight vector corresponding to the same class, calculate a difference between the current sample and each of the candidate samples to obtain plural candidate sample differences, and determine a predicted value of the at least one missing value of the current sample and a class corresponded by the current sample in accordance with the candidate sample differences, in which the candidate samples correspond to the classes in a one-to-one manner.

In some embodiments, the nonlinear inequality constraint is a quadratic inequality constraint.

In some embodiments, the step for calculating the base matrix and the weight matrix which are corresponded by each of the classified historical sample groups is performed by using an alternating least squares (ALS) algorithm and class-dependent data imputation.

In some embodiments, the ALS algorithm is a ridge alternating least squares (RALS) algorithm.

In some embodiments, the candidate sample calculating step involves multiplying the base matrix by the weight vector to obtain each of the candidate samples.

### BRIEF DESCRIPTION OF THE DRAWINGS

The invention can be more fully understood by reading the following detailed description of the embodiment, with reference made to the accompanying drawings as follows.

FIG. 1 is a schematic diagram showing a functional diagram of a system for data imputation and classification in accordance with embodiments of the present invention.

FIG. 2 is a flow chart showing the method for data imputation and classification in accordance with embodiments of the present invention.

FIG. 3 is a schematic diagram showing historical samples in accordance with an embodiment of the present invention.

FIG. 4 is a schematic diagram showing classified historical sample groups in accordance with an embodiment of the present invention.

FIG. 5 is a schematic diagram showing a base matrix and a weight matrix in accordance with an embodiment of the present invention.

FIG. 6 is a schematic diagram showing a predicted sample matrix in accordance with an embodiment of the present invention.

FIG. 7 is a schematic diagram showing a current sample in accordance with an embodiment of the present invention.

### DETAILED DESCRIPTION

The using of “first”, “second”, “third”, etc. in the specification should be understood for identifying units or data described by the same terminology, but are not referred to particular order or sequence.

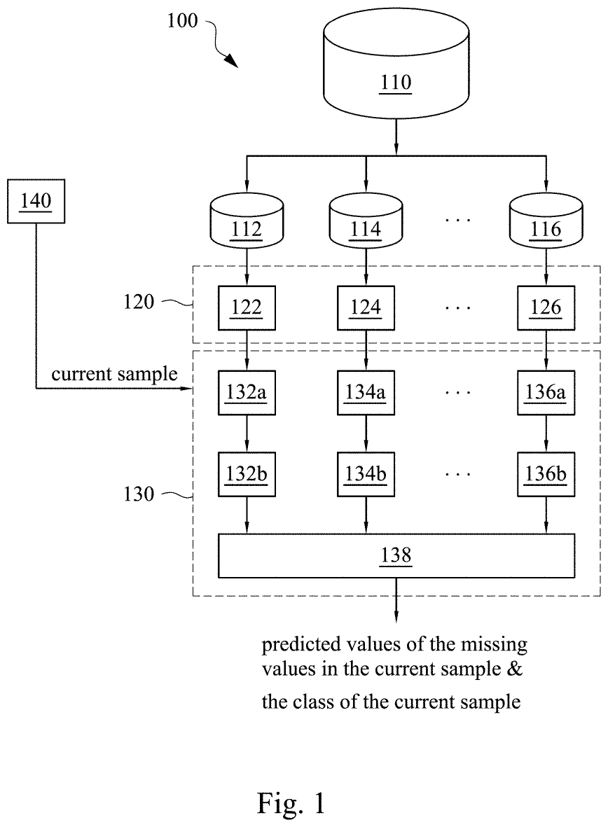

Referring to FIG. 1, FIG. 1 is a schematic diagram showing a functional diagram of a system 100 for data imputation and classification in accordance with embodiments of the present invention. The system 100 includes a database 110, an imputation calculating module 120 for historical samples, and an imputation and classification module 130 for the current sample. The database is configured to store historical samples. In an embodiment of the present invention, the historical samples are classified into plural classified historical sample groups, for example classified historical sample groups 112, 114 and 116. The classified historical sample groups 112, 114 and 116 correspond to plural classes in a one-to-one manner, and are stored in a form of subset of the database 110.

The imputation calculating module 120 is configured to calculate base matrixes and weight matrixes which are corresponded by the classified historical sample groups, thereby imputing missing values of the classified historical sample groups. The imputation calculating module 120 includes plural basis factor generation modules, for example basis factor generation modules 122, 124 and 126. The basis factor generation modules 122, 124 and 126 are configured to receive the classified historical sample groups 112, 114 and 116, and to calculate a base matrix and a weight matrix which are corresponded by each of the classified historical sample groups 112, 114 and 116. Predicted values of the missing values of each of the classified historical sample group can be derived according to the base matrix and the weight matrix which are corresponded by each of the classified historical sample groups.

The imputation and classification module 130 is configured to receive new data (also referred as to “current sample” hereinafter) provided from an external device 140, and to impute and classify the current sample to obtain predicted values of missing values of the current sample and to obtain the class corresponded by the current sample. The imputation and classification module 130 includes plural weight factor generation modules (for example, weight factor generation modules 132a, 134a and 136a), plural data reconstruction modules (for example, data reconstruction modules 132b, 134b and 136b) and a determination module 138. The weight factor generation modules 132a, 134a and 136a are configured to generate weight factors of the current sample corresponding to respective classes. The data reconstruction modules 132b, 134b and 136b are configured to generate plural candidate samples of the current sample corresponding to respective classes. The determination module 138 is configured to determine predicted values of the missing values of the current sample and a class corresponded by the current sample in accordance with the candidate samples. In the following embodiments, algorithms used by the imputation calculating module 120 and the imputation and classification module 130 are introduced.

At first, an M-by-N sample matrix X with missing values is provided, in which M signifies the number of dimensions (also referred to as “a number of independent variables”), and N denotes the number of observed samples. Thereafter, an objective function for matrix completion is provided. In this embodiment, a ridge alternating least squares (RALS) algorithm is used to obtain the objective function for matrix completion, but embodiments of the present invention are not limited thereto. In other embodiments of the present invention, other alternating least squares algorithms can be used to obtain the objective function.

When the Ridge ALS algorithm is used to obtain the objective function for matrix completion, a difference between the matrix X and a matrix formed by a matrix U and a matrix V for objective minimization can be expressed as:

min E_{rALS}(U,V)=min{∥X− [symbol] +ρ_{U} [symbol] +ρ_{V} [symbol] (1)

Where U and V are respectively M-by-D and D-by-N unknown matrixes; D is the intermediate dimension; ∥⋅ [symbol] represents the Frobenius norm; ρ_{U} and ρ_{V} represent the ridge parameters for U and V, respectively. Ridge parameters are used to regularize and prevent U and V from overfitting. To find U and V, following equations (2) and (3) are used.

V=(U^{τ}U+ρ_{V}I)⁻¹U^{τ}×G(X) (2)

U^{τ}=(VV^{τ}+ρ_{U}I)⁻¹V×G(X)^{τ} (3)

Where τ is the transpose operator, and an element-wise mask G is imposed on X. If an element of X is missing, the missing element is temporally replaced by a value of zero. In addition, the above equations (2)-(3) are presented in matrixes for the purpose of convenience.

It is assumed that y is an N-by-1 vector containing the class labels (also referred to as “categorical variables”). The vector y corresponds to samples in the sample matrix X. Further, it is assumed that the number of the classes is L. Therefore, the sample matrix X can be divided into [symbol] , and [symbol] =1, . . . ,L. The size of [symbol] is M× [symbol] , where N₁+N₂+ . . . +N_{L}=N. In the embodiments of the present invention, to reflect characteristics of values corresponding to the classes, a class-dependent data imputation algorithm is used to find class-dependent matrix factors [symbol] and [symbol] , and then a refining step is performed. The class-dependent matrix factors [symbol] and [symbol] can be expressed as:

[symbol]

=( [symbol] [symbol] + [symbol] I)⁻¹ [symbol] ×G( [symbol] ) (4)

[symbol]

=( [symbol] [symbol] + [symbol] I)⁻¹ [symbol] ×G( [symbol] )^{T} (5)

In the above equations, only corresponding [symbol] is used to find [symbol] and [symbol] . Through the above step, the class-dependent matrix factors corresponding to each of the classes can be found.

Thereafter, it is assumed that t is the current sample provided by the external device, and t is an M-by-1 matrix with missing values. Regarding the current sample t, it is assumed that a D-by-1 weight vector [symbol] can satisfy the following equation:

t˜ [symbol] [symbol] (6)

The current sample t belongs to a vector space spanned by [symbol] , i.e., span( [symbol] ). However, the formation of the weight vector [symbol] has various possibilities. Therefore, embodiments of the present invention provide a “weight factors formation technology for imputation based on quadratic inequality constraints” which can limit the possibilities of the formation of the weight vector [symbol] . The “weight factors formation technology for imputation based on quadratic inequality constraints” in the embodiments of the present invention uses the Ridge ALS algorithm with quadratic inequality constraints, but embodiments of the present invention are not limited thereto. In other embodiments, other alternating least squares algorithms with quadratic inequality constraints can be used to limit the weight vector [symbol] .

Regarding the Ridge ALS algorithm with quadratic inequality constraints, the equation thereof can be expressed as:

$$min {E}_{tALS}^{t} ( ) = min \{ ‖ t - + , s . t . ‖ - \leq \qquad ( 7 )$$

Where [symbol] is a D-by-1 vector and the centroid of [symbol] . In addition, [symbol] is a predefined radius, and [symbol] >0. Equation (7) can be generalized as:

$$min {E}_{t ALS}^{\#} ( ) = min \{ + , \leq {δ}_{t}^{2} \qquad ( 8 )$$

Where [symbol] is a q-by-D Tikhonov matrix, [symbol] is a p-by-D weight matrix, and [symbol] is a p-by-1 shift vector (e.g., [symbol] ). To solve equation (8), high-order generalized singular value decomposition (GSVD) is used. How the GSVD is used for [symbol] , [symbol] , and [symbol] is introduced below. For simplicity, subscript [symbol] is omitted herein. It is assumed that after the high-order GSVD is introduced. [symbol] , [symbol] , and [symbol] can be expressed as:

$$\begin{matrix}{S}_{U} = {Q}_{U}^{T} UR & ( 9 ) \\ {S}_{B} = {Q}_{B}^{T} BR & ( 10 ) \\ {S}_{Γ} = {Q}_{Γ}^{T} Γ R & ( 11 )\end{matrix}$$

Where Q denotes a unitary matrix and R is a nonsingular matrix. In addition, the off-diagonal terms of S are zeros. It is assumed that μ, β, γ represent diagonal terms for matrixes S_{U}, S_{B}, and S_{Γ}, respectively. Then, matrixes S_{U}, S_{B}, and S_{Γ} can be expressed as:

$$\begin{matrix}{S}_{U} = diag ( {μ}_{1} , {μ}_{2} , … , {μ}_{D} ) & ( 12 ) \\ {S}_{B} = diag ( {β}_{1} , {β}_{2} , … , {β}_{z} ) & ( 13 ) \\ {S}_{Γ} = diag ( {γ}_{1} , {γ}_{2} , … , {γ}_{g} ) & ( 14 )\end{matrix}$$

Meanwhile, z=min{p,D}, q≤D and D≤M. Based on equations (9)-(14), equation (7) is simplified as:

$$min {E}_{t ALS}^{\#} ( \tilde{v} ) = min \{ ‖ \overline{t} - + ρ ‖ {S}_{Γ} \} , s . t . ‖ {S}_{B} \overline{v} - \leq {δ}^{2} \qquad ( 15 )$$

Where \tilde{t}=Q_{U}^{T}t, \tilde{b}=Q_{B}^{T}b and \tilde{v}=R⁻¹v. By introducing a Lagrangian multiplier λ equation (15) can be modified as:

$$min ( \tilde{v} ) = min \{ ‖ \tilde{t} - + ρ ‖ {S}_{Γ} + λ ( ‖ {S}_{B} \tilde{v} - - {δ}^{2} ) \} \qquad ( 16 )$$

By taking the derivative of [symbol] (\tilde{v}) with respect to \tilde{v}, and by zeroing the result, following equation (17) is obtained:

$$( {S}_{U}^{τ} {S}_{U} + ρ {S}_{Γ}^{τ} {S}_{Γ} + λ {S}_{H}^{T} {S}_{H} ) \tilde{v} = {S}_{U}^{T} \tilde{t} + λ {S}_{B}^{T} \overline{b} \qquad ( 17 )$$

Equation (17) can be converted into a function of λ, i.e., \tilde{v}(λ). It is assumed that r is the rank of the matrix B, and three cases of the function \tilde{v}(λ) are discussed as follows after rearrangement of equation (17).

$$\begin{matrix}Case 1 \text{:} when z = p \leq q , & \\ \tilde{v} ( λ ) = \{ \begin{matrix}\frac{{μ}_{i} {\tilde{t}}_{i} + λ {β}_{i} {\tilde{b}}_{i}}{{μ}_{i}^{2} + {ργ}_{i}^{2} + {λβ}_{l}^{2}} & j = 1 , … , z \\ \frac{{μ}_{i} {\overline{t}}_{i}}{{μ}_{i}^{2} + {ργ}_{i}^{2}} & j = z + 1 , … , q \\ \frac{{\tilde{t}}_{i}}{{μ}_{i}} & j = q + 1 , … , D\end{matrix} & ( 18 ) \\ Case 2 \text{:} when z = p > q , & \\ \tilde{v} ( λ ) = \{ \begin{matrix}\frac{{μ}_{i} {\tilde{t}}_{i} + λ {β}_{i} {\tilde{b}}_{i}}{{μ}_{i}^{2} + {ργ}_{i}^{2} + {λβ}_{l}^{2}} & j = 1 , … , q \\ \frac{{μ}_{i} {\overline{t}}_{i} + {λβ}_{i} {\tilde{b}}_{i}}{{μ}_{i}^{2} + {λβ}_{i}^{2}} & j = q + 1 , … , z \\ \frac{{\tilde{t}}_{i}}{{μ}_{i}} & j = z + 1 , … , D\end{matrix} & ( 19 ) \\ Case 3 \text{:} when z = D , & \\ \tilde{v} ( λ ) = \{ \begin{matrix}\frac{{μ}_{i} {\tilde{t}}_{i} + λ {β}_{i} {\tilde{b}}_{i}}{{μ}_{i}^{2} + {ργ}_{i}^{2} + {λβ}_{l}^{2}} & j = 1 , … , q \\ \frac{{μ}_{i} {\overline{t}}_{i} + {λβ}_{i} {\tilde{b}}_{i}}{{μ}_{i}^{2} + {λβ}_{i}^{2}} & j = q + 1 , … , z\end{matrix} & ( 20 )\end{matrix}$$

To minimize equation (16), ∥S_{B}\tilde{v}− [symbol] −δ² should be zero. After substitution of equations (18)-(20) into ∥S_{B}\tilde{v}− [symbol] respectively, a function ϕ(λ) is obtained. The function ϕ(λ) can be expressed as:

When r>q,

$$φ ( λ ) = {\sum }_{j = 1}^{q} \frac{{μ}_{j} {β}_{j} {\tilde{t}}_{j} - {μ}_{j}^{2} {\tilde{b}}_{j} - {ργ}_{j}^{2} {\tilde{b}}_{j}}{{μ}_{j}^{2} + {ργ}_{j}^{2} + {λβ}_{j}^{2}} + {\sum }_{j = q + 1}^{r} \frac{{μ}_{j} {β}_{j} {\tilde{t}}_{j} - {μ}_{j}^{2} {\tilde{b}}_{j}}{{μ}_{j}^{2} + {λβ}_{j}^{2}} + {\sum }_{j = r + 1}^{p} {\tilde{b}}_{j} \qquad ( 21 )$$

### Otherwise,

$$φ ( λ ) = {\sum }_{j = 1}^{r} \frac{{μ}_{j} {β}_{j} \overline{t} - {μ}_{j}^{2} {\tilde{b}}_{j}}{{μ}_{j}^{2} + {λβ}_{j}^{2}} + {\sum }_{j = r + 1}^{μ} {\tilde{b}}_{j} \qquad ( 22 )$$

Thereafter, λ is calculated. It is assumed that ϕ(λ) is equal to δ², then λ is obtained. Then, \tilde{v} is calculated. Plugging the value of λ into equation (18), (19), or (20), \tilde{v} can be obtained. Thereafter, v is calculated. Plugging \tilde{v} into following equation (23):

v=R\tilde{v} (23)

Thus, v can be obtained.

Thereafter, how to use the weight vector v to perform the imputation is introduced below.

In the embodiments of the present invention, an “iterative projection pursuit (IPP) algorithm with quadratic inequality constraints” is used to perform the imputation. However, embodiments of the present invention are not limited thereto. In other embodiments of the present invention, other IPP algorithms with nonlinear inequality constraints can be used to perform the imputation.

In calculation of the imputation of this embodiment, at first, the above class [symbol] is used to initialize the current sample t to replace missing values in the current sample t with zeros. Thereafter, a first step is performed to calculate [symbol] in accordance with the above “weight factors formation technology for imputation based on quadratic inequality constraints”. In the calculation for [symbol] , at first, [symbol] [i] is plugged into equation (21) or (22) to calculate ϕ( [symbol] )[i], and [symbol] [i] is obtained, in which i represents the i-th iteration. Then, [symbol] [i] is plugged into equations (18), (19) or (20) to obtain [symbol] ( [symbol] )[i]. Thereafter, [symbol] [i] is calculated, in which [symbol] [i]=Rₗ× [symbol] ( [symbol] )[i].

Then, a second step is performed to calculate predicted values of the missing values in the current sample t, in which the calculation of the predicted values performs imputation by using the following equations:

[symbol]

[i]= [symbol] × [symbol] [i] (24)

[symbol]

[i+1]=t⊕ [symbol] [i] (25)

Where the operator ⊕ in equation (25) means to replace the missing values of t with the imputed ones of \hat{t}.

The above first step and the second step are repeated until a root-mean-square error (RMSE) [symbol] converges, in which the RMSE [symbol] can be expressed as:

$${ɛ}_{𝓁} = \sqrt{( {\sum }_{m = 1}^{M} {e}_{𝓁 , m}^{2} [ i + 1 ] ) / M} \qquad ( 26 )$$

where

[symbol]

[i+1]=G(t− [symbol] [i+1]) (27)

Then, the smallest [symbol] is selected to determine the class of the current sample t, in which an equation of the selection is expressed as:

$${𝓁}^{*} = {argmin}_{𝓁} {ɛ}_{𝓁} \qquad ( 28 )$$

Where [symbol] is the class of the current sample t.

Hereinafter, an embodiment is introduced for explaining a method 200 for data imputation and classification corresponded by the system 100.

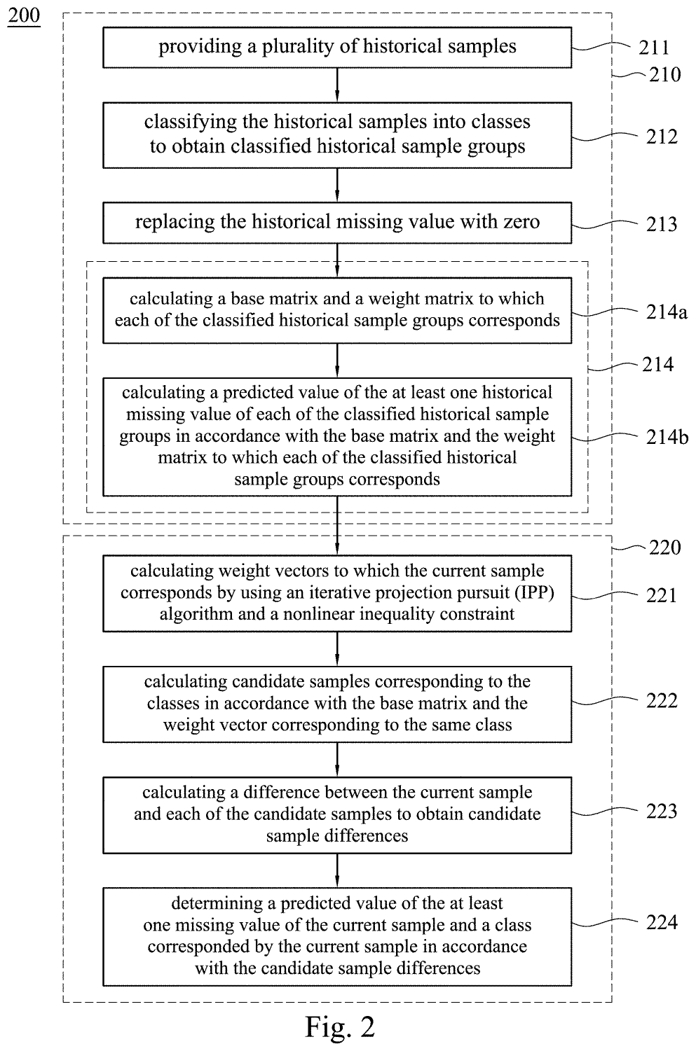

Referring to FIG. 2, FIG. 2 is a flow chart showing the method 200 for data imputation and classification. The method 200 includes a historical sample processing stage 210 and a sample classification stage 220. The historical sample processing stage 210 is performed by using the above imputation calculating module 120 for historical samples, and the sample classification stage 220 is performed by using the above imputation and classification module 130 for the current sample.

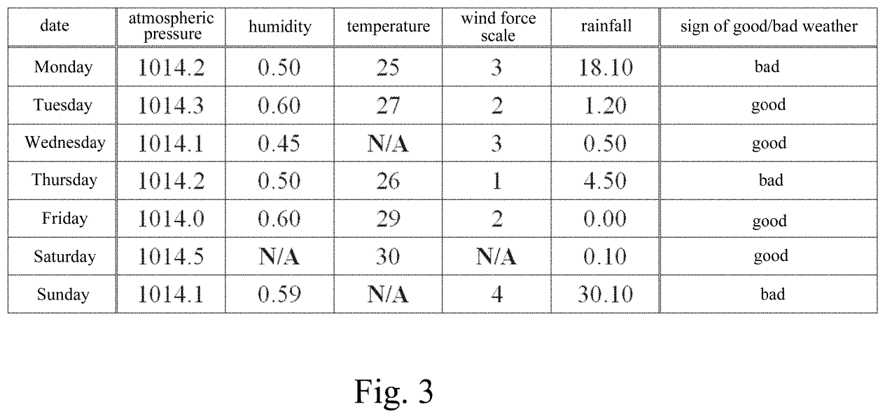

In the historical sample processing stage 210, at first, step 211 is performed to provide plural historical samples, as shown in FIG. 3. In this embodiment, the historical samples include eight samples corresponding to weather information of seven days. Each of the historical samples includes five values: atmospheric pressure, humidity, temperature, wind force scale and rainfall. In the historical samples, the temperature of Tuesday, the humidity and wind force scale of Saturday and temperature of Sunday are missing values. In addition, the historical samples are classified into good weather and bad weather. However, in other embodiments of the present invention, if the historical samples are not classified, a classification module can be added to the imputation calculating module 120 to perform a classification step 212 on the historical samples.

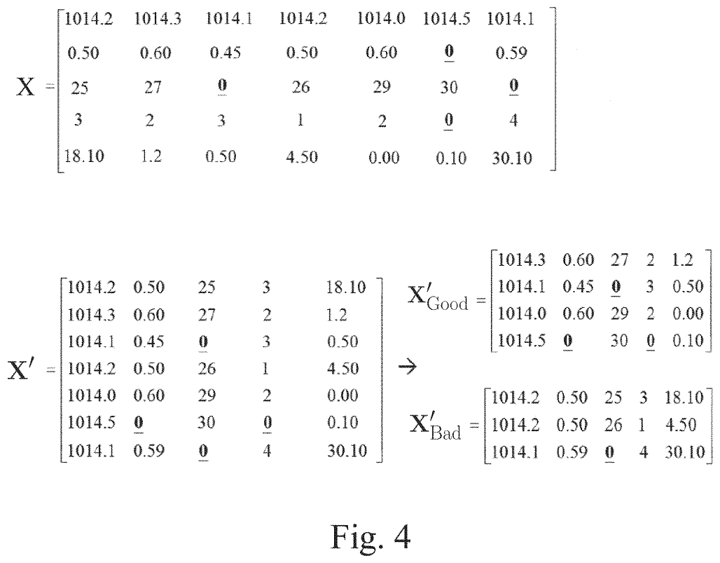

Thereafter, step 213 is performed to replace the historical missing values with zeros, as shown in FIG. 4. In FIG. 4, the transpose operation is performed on the historical samples X to obtain historical samples X′. The historical samples X′ can be divided into two classified historical sample groups X_{Good}′ and X_{Bad}′ in accordance with the classes of the historical samples X′, in which the classified historical sample group X_{Good}′ corresponds to a class of good weather, and the classified historical sample group X_{Bad}′ corresponds to a class of bad weather.

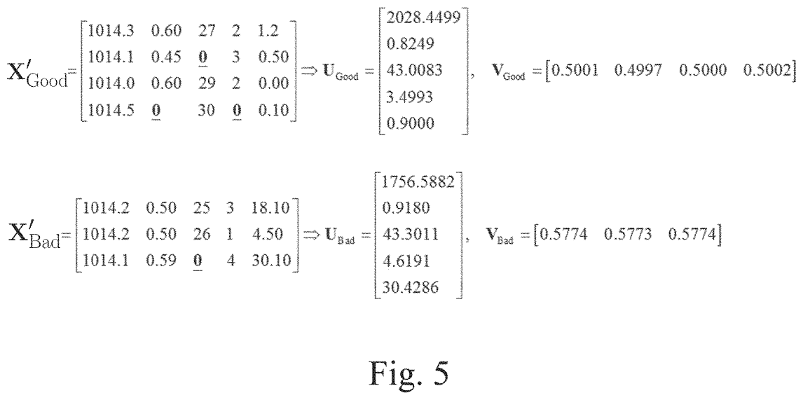

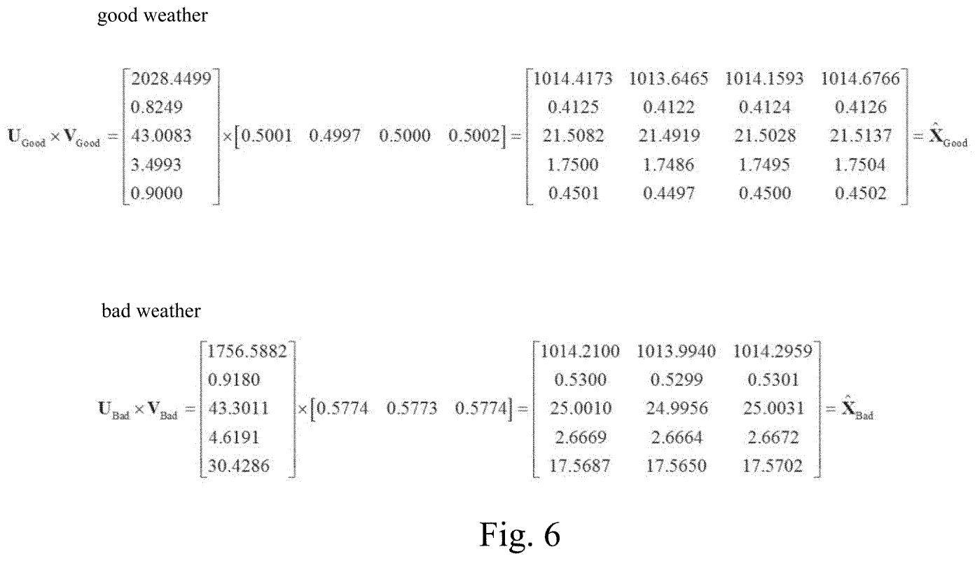

Then, step 214 is performed to perform imputation based on each of the classified historical sample groups X_{Good}′ and X_{Bad}′. In the embodiments of the present invention, step 214 is performed by using the above basis factor generation modules, for example the basis factor generation modules 122, 124 and 126. In step 214, at first, step 214a is performed to calculate a base matrix and a weight matrix which are corresponded by each of the classified historical sample groups X_{Good}′ and X_{Bad}′, as shown in FIG. 5. By using the equations (2)-(3), the classified historical sample group X_{Good}′ can be decomposed into a base matrix U_{Good} and a weight matrix V_{Good}. Similarly, by using the equations (2)-(3), the classified historical sample group X_{Bad}′ can be decomposed into a base matrix U_{Bad} and a weight matrix V_{Bad}. Thereafter, step 214b is performed to calculate a predicted value of the at least one historical missing value of each of the classified historical sample groups X_{Good}′ and X_{Bad}′ in accordance with the base matrix and the weight matrix which are corresponded by each of the classified historical sample groups X_{Good}′ and X_{Bad}′. As shown in FIG. 6, in step 214b, the base matrix U_{Good} is multiplied by the weight matrix V_{Good} to obtain a predicted sample matrix \hat{X}_{Good}, and then the missing values of the classified historical sample groups X_{Good}′ can be obtained through the predicted sample matrix \hat{X}_{Good}. Similarly, the base matrix U_{Bad} is multiplied by the weight matrix V_{Bad} to obtain a predicted sample matrix \hat{X}_{Bad}, and then the missing values of the classified historical sample groups X_{Bad}′ can be obtained through the predicted sample matrix \hat{X}_{Bad}. In an embodiment of the present invention, the transpose operation can be performed on the predicted sample matrixes \hat{X}_{Good} and \hat{X}_{Bad} to enable the numbers of columns and rows thereof to be the same as the numbers of columns and rows of the classified historical sample groups X_{Good}′ and X_{Bad}′, and thus the predicted values of the missing values can be obtained by comparison.

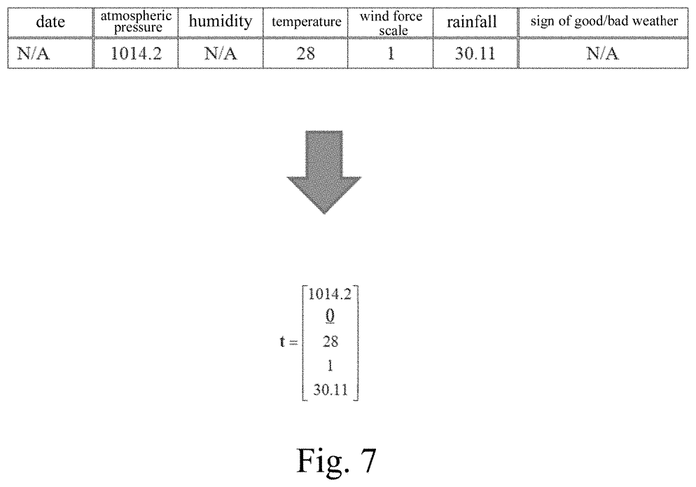

In the sample classification stage 220, at first, step 221 is performed to calculate weight vectors which are corresponded by a current sample t by using the iterative projection pursuit (IPP) algorithm and a nonlinear inequality constraint. The weight vectors correspond to the above classes, for example good weather and bas weather in a one-to-one manner. In this embodiment of the present invention, the above iterative projection pursuit (IPP) algorithm with quadratic inequality constraints is used to calculate the weight vectors which is corresponded by the current sample t. As shown in FIG. 7, the current sample is weather information of one day, in which the miss value of humidity is replaced by zero. A parameter λ_{Good} of the current sample t corresponding to good weather is calculated by using equations (21) and (22), and then a weight vector v_{Good} of the current sample t corresponding to good weather is calculated by using equations (18), (19), (20), (23) and the parameter λ_{Good}, in which the parameter λ_{Good} is used to limit the content of the weight vector v_{Good}. Similarly, a parameter λ_{Bad} of the current sample t corresponding to bad weather is calculated by using equations (21) and (22), and then a weight vector v_{Bad} of the current sample t corresponding to bad weather is calculated by using equations (18), (19), (20), (23) and the parameter λ_{Bad}, in which the parameter λ_{Bad} is used to limit the content of the weight vector v_{Bad}.

In step 222, candidate samples corresponding to the classes are calculated in accordance with the base matrix and the weight vector corresponding to the same class. For example, the base matrix U_{Good} and the weight vector v_{Good} correspond to the class of good weather, and thus a candidate sample corresponding to good weather can be calculated in accordance with the base matrix U_{Good} and the weight vector v_{Good}. In this embodiment, the base matrix U_{Good} is multiplied by the weight vector v_{Good} (i.e., U_{Good}×v_{Good}) to obtain a candidate sample t_{Good} corresponding to good weather. Similarly, the base matrix U_{Bad} and the weight vector v_{Bad} correspond to the class of bad weather, and thus a candidate sample corresponding to bad weather can be calculated in accordance with the base matrix U_{Bad} and the weight vector v_{Bad}. In this embodiment, the base matrix U_{Bad} is multiplied by the weight vector v_{Bad} (i.e., U_{Bad}×v_{Bad}) to obtain a candidate sample t_{Bad} corresponding to bad weather.

In step 223, a difference between the current sample t and each of the candidate samples is calculated to obtain candidate sample differences. In this embodiment, differences between the known values of the current sample t and corresponding values of the candidate samples t_{Good} and t_{Bad} are calculated by using equation (26) to obtain a sample difference of good weather between the current sample t and the candidate sample t_{Good}, and to obtain a sample difference of bad weather between the current sample t and the candidate sample t_{Bad}. However, embodiments of the present invention are not limited thereto. In other embodiments of the present invention, other methods can be used to calculate the differences between the current sample and the candidate samples.

In step 224, a predicted value of the at least one missing value of the current sample t and a class corresponded by the current sample t are determined in accordance with the candidate sample differences. In this embodiment, the candidate sample with the smallest difference is determined as a correct sample in accordance with equation (28), and then the predicted values of the missing values in the current sample t and the class corresponded by the current sample t are determined in accordance with the correct sample. For example, when the candidate sample difference corresponded by the candidate sample t_{Good} is smaller than the candidate sample difference corresponded by the candidate sample t_{Bad}, the candidate sample t_{Good} is determined as the correct sample. Thereafter, predicted values of the missing values in the current sample t can be obtained by comparing the candidate sample t_{Good} with the current sample t. In addition, since the candidate sample t_{Good} corresponds to the class of good weather, the current sample t is determined as good weather.

It can be understood from the above descriptions that the embodiments of the present invention performs imputation on samples with missing values, and differentiated and nonlinear imputation factors are used for samples corresponding to different classes, thereby obtaining imputed values closer to the true values from real statistical distributions. Therefore, the method 200 for data imputation and classification in the embodiments of the present invention is more precise.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims.

What is claimed is:

1. A method for data imputation and classification, the method comprising:
performing a historical sample processing stage, wherein the historical sample processing stage comprises:
providing a plurality of historical samples;
classifying the historical samples into a plurality of classes to obtain a plurality of classified historical sample groups, wherein the classified historical sample groups correspond to the classes in a one-to-one manner, and each of the classified historical sample groups comprises a plurality of known historical values and at least one historical missing value;
replacing the historical missing value with zero; and
performing an imputation calculating step on each of the classified historical sample groups, wherein the imputation calculating step comprises:
calculating a base matrix and a weight matrix which are corresponded by each of the classified historical sample groups;
calculating a predicted value of the at least one historical missing value of each of the classified historical sample groups in accordance with the base matrix and the weight matrix to which each of the classified historical sample groups corresponds; and
performing a sample classification stage to classify a current sample into one of the classes, wherein the current sample comprises a plurality of known values and at least one missing value, and the sample classification stage comprises:
calculating a plurality of weight vectors corresponded by the current sample by using an iterative projection pursuit (IPP) algorithm and a nonlinear inequality constraint, wherein the weight vectors correspond to the classes in a one-to-one manner, each of the weight vectors is limited by a weight parameter, and the weight parameter is calculated in accordance with the nonlinear inequality constraint;
performing a candidate sample calculating step to calculate a plurality of candidate samples corresponding to the classes in accordance with the base matrix and the weight vector corresponding to the same class, wherein the candidate samples correspond to the classes in a one-to-one manner;
calculating a difference between the current sample and each of the candidate samples to obtain a plurality of candidate sample differences; and
determining a predicted value of the at least one missing value of the current sample and a class corresponded by the current sample in accordance with the candidate sample differences.

2. The method for data imputation and classification of claim 1, wherein the nonlinear inequality constraint is a quadratic inequality constraint.

3. The method for data imputation and classification of claim 1, wherein the step for calculating the base matrix and the weight matrix which are corresponded by each of the classified historical sample groups is performed by using an alternating least squares (ALS) algorithm and class-dependent data imputation.

4. The method for data imputation and classification of claim 3, wherein the ALS algorithm is a ridge alternating least squares (RALS) algorithm.

5. The method for data imputation and classification of claim 1, wherein the candidate sample calculating step involves multiplying the base matrix by the weight vector to obtain each of the candidate samples.

6. A system for data imputation and classification comprising:
a database, configured to store a plurality of classified historical sample groups, wherein the classified historical sample groups correspond to a plurality of classes in a one-to-one manner, and each of the classified historical sample groups comprises a plurality of known historical values and at least one historical missing value;
an imputation calculating module for the historical samples, configured to:
replace the historical missing value with zero;
calculate a base matrix and a weight matrix which are corresponded by each of the classified historical sample groups; and
calculate a predicted value of the at least one historical missing value of each of the classified historical sample groups in accordance with the base matrix and the weight matrix which are corresponded by each of the classified historical sample groups; and
an imputation and classification module for a current sample, configured to receive the current sample provided from an external device, and configured to:
calculate a plurality of weight vectors corresponded by the current sample by using an iterative projection pursuit (IPP) algorithm and a nonlinear inequality constraint, wherein the weight vectors correspond to the classes in a one-to-one manner, each of the weight vectors is limited by a weight parameter, and the weight parameter is calculated in accordance with the nonlinear inequality constraint;
perform a candidate sample calculating step to calculate a plurality of candidate samples corresponding to the classes in accordance with the base matrix and the weight vector corresponding to the same class, wherein the candidate samples correspond to the classes in a one-to-one manner;
calculate a difference between the current sample and each of the candidate samples to obtain a plurality of candidate sample differences; and
determine a predicted value of the at least one missing value of the current sample and a class corresponded by the current sample in accordance with the candidate sample differences.

7. The system for data imputation and classification of claim 6, wherein the nonlinear inequality constraint is a quadratic inequality constraint.

8. The system for data imputation and classification of claim 6, wherein the step for calculating the base matrix and the weight matrix which are corresponded by each of the classified historical sample groups is performed by using an alternating least squares (ALS) algorithm and class-dependent data imputation.

9. The system for data imputation and classification of claim 8, wherein the ALS algorithm is a ridge alternating least squares (RALS) algorithm.

10. The system for data imputation and classification of claim 6, the candidate sample calculating step involves multiplying the base matrix by the weight vector to obtain each of the candidate samples.
